(19) United States
(12) Patent Application Publication
(10) Pub. No.: US 2014/0147132 A1
(43) Pub. Date: May 29, 2014

(54) IMAGE FORMING APPARATUS

(71) Applicant: Konica Minolta , Inc., Tokyo (JP)

(72) Inventors: Masahiro KOUZAKI, Toyohashi-shi (JP); Mitsuru OBARA, Toyohashi-shi (JP); Soh HIROTA, Toyohashi-shi (JP); Yoshinori TSUTSUMI, Toyohashi-shi (JP)

(73) Assignee: Konica Minolta , Inc., Tokyo (JP)

(21) Appl. No.: 14/085,012

(22) Filed: Nov. 20, 2013

(30) Foreign Application Priority Data
Nov. 27, 2012 (JP) 2012-258061

(51) Int. Cl. G03G 15/00

(52) U.S. Cl. CPC G03G 15/5062
USPC 399/9; 399/24; 399/23

(57) ABSTRACT

An image forming apparatus is provided which can execute an image stabilization operation and which includes: a determination portion that determines whether or not the image stabilization operation can be executed when a constituent member of the apparatus is replaced or when a consumable item is supplied; and an image stabilization control portion that executes the image stabilization operation when the determination portion determines that the image stabilization operation can he executed.

### BACKGROUND OF THE INVENTION

1. Field of the Invention

The present invention relates to an image forming apparatus and more particularly relates to an image forming apparatus that executes an image stabilization operation at a predetermined time.

2. Description of the Related Art

In an image forming apparatus such as a facsimile, a printer or a copying machine, variations in temperature and humidity within the apparatus and the degradation of a component such as a photosensitive drum or a developer change optimum control variables for image formation. Hence, an image stabilization operation is executed under constant conditions, and thus control variables for the individual portions of the apparatus are changed, with the result that print image quality is maintained to be equal to or more than a given level that is required.

As an image stabilization method, there are an open control method of switching a condition table and a feedback control method of detecting the state of an image pattern actually output to derive optimum conditions. In the feedback control, a series of control steps below are executed: the occurrence of a pattern→the production of an image→detection→the execution of a condition determination algorithm→the determination of optimum conditions.

Examples of the time when the image stabilization operation is executed generally include the following times:
the time when the constituent members of the apparatus such as a development unit are replaced, the time when they are inserted or removed and the time when power is turned on
environmental changes, the total number of sheets of images formed and a time elapsed from the previous execution of the image stabilization operation; and
an arbitrary time when a user or a maintenance operator requires the image stabilization operation

In a large number of image forming apparatuses, a setting is made such that the image stabilization operation is performed not at any one of the times described above but at a plurality of times described above. A different type of image stabilization operation is performed for each condition. In a case where a large number of sheets of images are formed, when the total number of sheets of images formed reaches a predetermined number of sheets, the image stabilization operation is often performed.

Incidentally, if the condition fix the execution of the image stabilization operation is fixed to a condition in which the total number of sheets of images formed reaches a predetermined number of sheets, an image stabilization operation that has not been required yet is executed many times, with the result that it is likely that the downtime is increased to make the user wait.

Hence, for example, patent document 1 (JP-A-4-194954) proposes that, since image formation cannot be performed when a paper feed cassette is removed, the image stabilization operation is executed when the paper feed cassettes is removed.

However, the execution of the image stabilization operation each time the paper feed cassettes is removed is likely to increase the downtime. In recent years, in some image forming apparatuses, a plurality of paper feed cassettes are provided, and, when sheets in a specified paper feed cassette run out, the paper feed cassette which feeds sheets is switched to another paper feed cassette, with the result that it is possible to continuously execute the image formation.

### SUMMARY OF THE INVENTION

Hence, an object of the present invention is to provide an image forming apparatus that executes an image stabilization operation without increasing downtime.

To achieve the above object, according to the present invention, there is provided an image forming apparatus that can execute an image stabilization operation, the image forming apparatus including: a determination portion that determines whether or not the image stabilization operation can be executed when a constituent member of the apparatus is replaced or when a consumable item is supplied; and an image stabilization control portion that executes the image stabilization operation when the determination portion determines that the image stabilization operation can be executed.

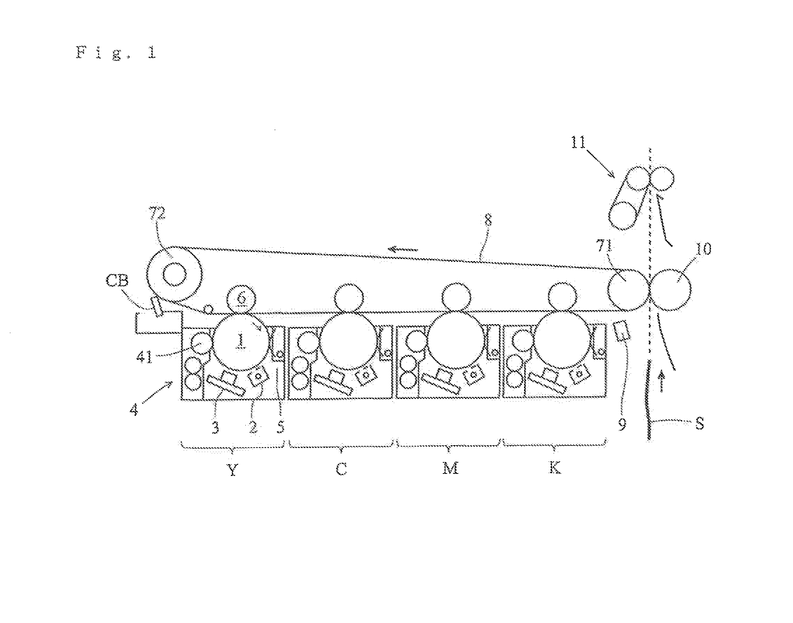

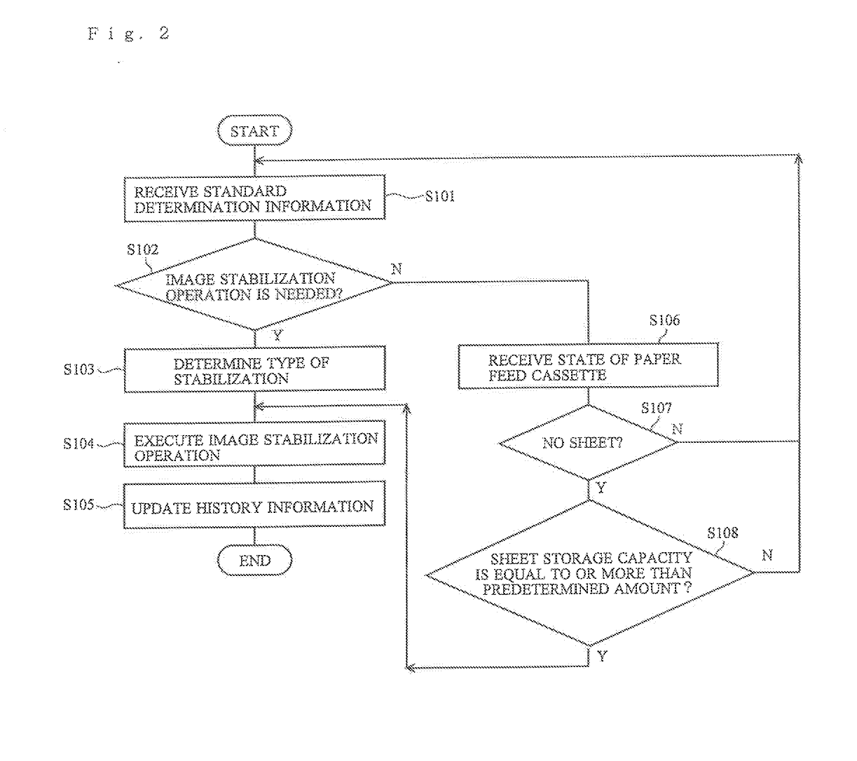

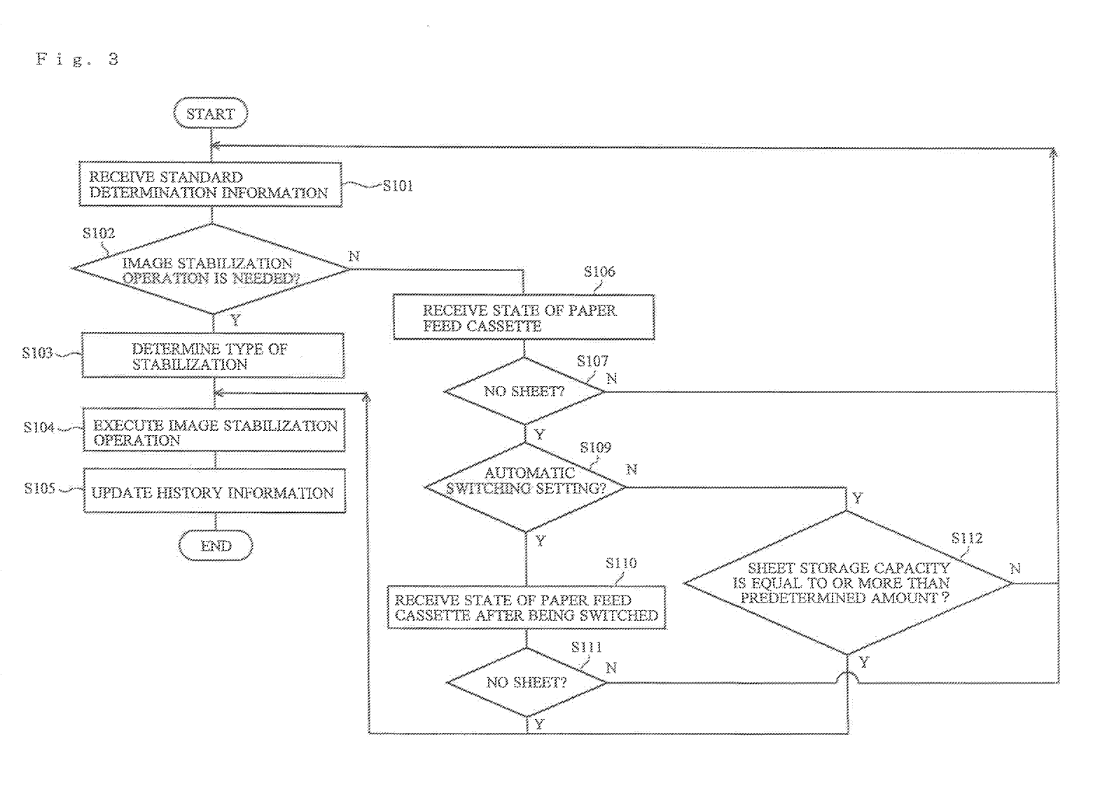

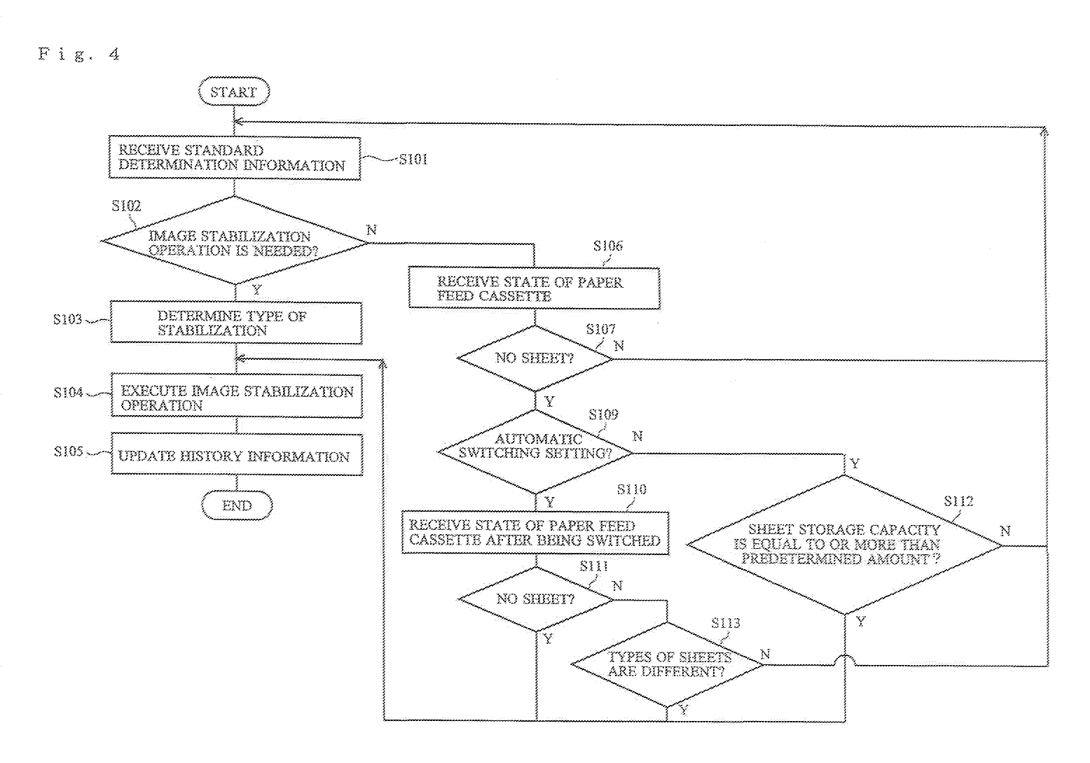

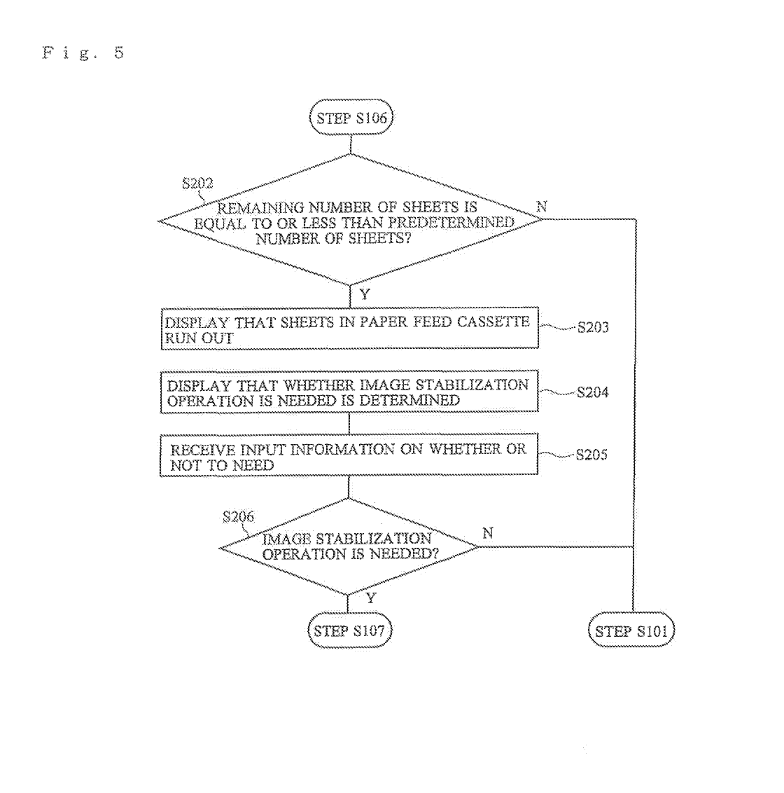

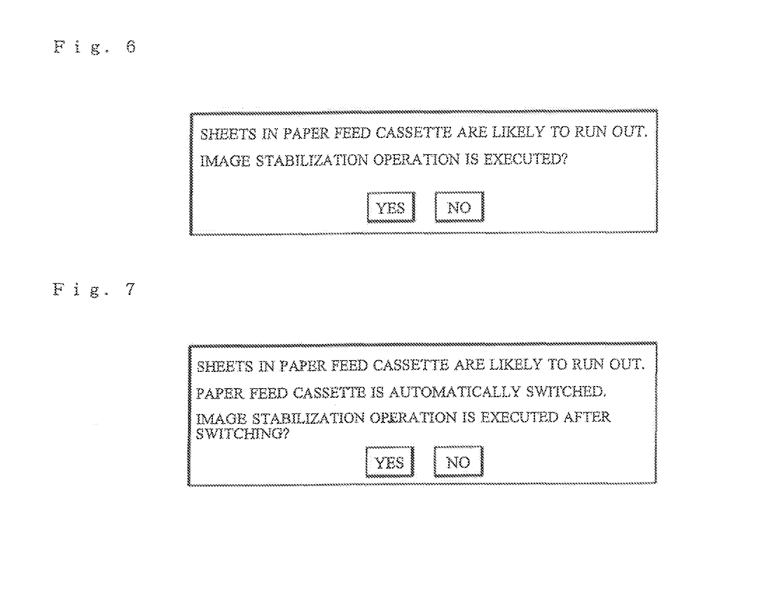

### BRIEF DESCRIPTION OF THE DRAWINGS

[FIG. 1] A schematic diagram showing an example of an image farming apparatus according to the present invention;

[FIG. 2] A flowchart showing an example of the control of an image stabilization operation;

[FIG. 3] A flowchart showing another example of the control of the image stabilization operation;

[FIG. 4] A flowchart showing yet another example of the control of the image stabilization operation;

[FIG. 5] A flowchart when whether or not the image stabilization operation is needed is previously input;

[FIG. 6] An example of a display for inquiring whether or not the execution of the image stabilization operation is needed; and

[FIG. 7] Another example of the display for inquiring whether or not the execution of the image stabilization operation is needed.

### DETAILED DESCRIPTION OF THE PREFERRED EMBODIMENTS

An image forming apparatus of the present invention will be described in detail below; however, the present invention is not limited to these embodiments, various modifications within a scope indicted by claims are possible and embodiments obtained by combining, as necessary, technical portions disclosed in different embodiments are also included in the technical scope of the present invention.

FIG. 1 is a schematic diagram showing an example of the image forming apparatus according to the present invention. The image forming apparatus of FIG. 1 is an electrophotographic image forming apparatus, and a tandem full-color image forming apparatus. This image forming apparatus includes an endless intermediate transfer belt 8 that is put around a roller 71 and a roller 72 and that is driven to be rotated in a counterclockwise direction in the figure (in a direction indicated by an arrow in the figure). Through the intermediate transfer belt 8, a cleaning blade CB that removes residual toner and the like on the intermediate transfer belt 8 is pressed onto the roller 72, and a secondary transfer roller 10 is pressed onto the roller 71. A fixing device 11 is arranged above the secondary transfer roller 10.

Between the roller 72 and the roller 71, along the intermediate transfer belt 8, from the roller 72 to the roller 71, a yellow image formation portion Y, a cyan image formation portion C, a magenta image formation portion M and a black image formation portion K are arranged in this order. Each of the image formation portions includes, as an image carrying member, a drum type photosensitive member 1; around the photosensitive member 1, a charging device 2, an image exposure device 3, a development device 4, a primary transfer roller 6 and a cleaner 5 for removing residual toner and the like on the photosensitive member 1 are arranged in this order. The primary transfer roller 6 is opposite the photosensitive member 1 through the intermediate transfer belt 8.

In the image forming apparatus configured as described above, image formation is performed as follows. In an example where a full-color image is thrilled using all the image formation portions Y, C, M and K, a yellow toner image is first formed in the yellow image formation portion Y, and is primarily transferred to the intermediate transfer belt 8. Specifically, in the yellow image formation portion Y, the photosensitive member 1 is driven to be rotated in the counterclockwise direction in the figure, the surface of the photosensitive member 1 is uniformly charged by the charging device 2 so as to have a predetermined potential, the charged region is subjected to image exposure for the yellow image from the image exposure device 3 and an electrostatic latent image for yellow is formed on the photosensitive member 1. This electrostatic latent image is developed, by a development roller 41 to which the development bias of the development device 4 having a yellow toner is applied, into a visible yellow toner image and the toner image is transferred onto the intermediate transfer belt 8 by the primary transfer roller 6 to which a primary transfer voltage is applied.

Likewise, in the cyan image formation portion C, a can toner image is formed and is transferred to the intermediate transfer belt 8, in the magenta image formation portion M, a magenta toner image is formed and is transferred to the intermediate transfer belt 8 and in the black image formation portion K, a black toner image is formed and is transferred to the intermediate transfer belt 8.

The yellow, cyan, magenta and black toner images are formed at such timing that they are superimposed and transferred onto the intermediate transfer belt 8. Then, the multiple toner images formed on the intermediate transfer belt 8 are moved to the secondary transfer roller 10 by the rotation of the intermediate transfer belt 8.

On the other hand, in synchronization with the multiple toner images on the intermediate transfer belt 8, a recording medium S is supplied, from an unillustrated supply portion, between the intermediate transfer belt 8 and the secondary transfer roller 10, and the multiple toner images are transferred, by the secondary transfer roller 10 to which a voltage is applied, onto the recording medium S. Then, the recording medium S is passed to the fixing device 11 where the multiple toner images are fixed to the recording medium S by being heated and pressurized, with the result that a predetermined color image is formed.

In the image forming apparatus described above, in the image stabilization operation, a test pattern toner image is formed in each of the image formation portions, this image is transferred onto the intermediate transfer belt 8, the state of the test pattern toner image on the intermediate transfer belt is detected with an optical detection sensor 9 and image formation conditions are adjusted based on detection values. Characteristics detected from the test pattern toner image include a maximum density characteristic, a line characteristic, a resist characteristic and a gradation characteristic. Then, based on the detection values, a development potential setting, an exposure light amount setting, an exposure start-up adjustment and a gradation reproduction curve adjustment and the like are performed.

The detection of the state of the test pattern toner image may be performed on the intermediate transfer belt 8, on the photosensitive member 1 or on the recording medium S. The detection sensor may directly read the test pattern toner image with a scanner. In this case, in particular, it is possible to detect the characteristic of the state of transfer/fixing on the recording medium S.

FIG. 2 shows a flowchart showing an example of the control of the image stabilization operation. Standard determination information that is a basis for whether or not it is necessary to execute the image stabilization operation is first received (step S101). The standard determination conditions include whether or not an environmental change is made from the previous execution, the total number of sheets, an elapsed time and like. Then, if the standard determination conditions are satisfied, the image stabilization operation is determined to be needed (step S102), and after the type of stabilization operation is determined (step S103), the image stabilization operation is executed (step S104). Thereafter, the history information on the execution of the image stabilization operation is updated (step S105).

On one hand, if it is determined from the standard determination conditions that the image stabilization operation has not been needed yet (step S102), the state of the paper feed cassette (whether or not sheets are present or the remaining number of sheets) is received (step S106). Then, if there is no sheet in the paper feed cassette (step S107), whether or not the sheet storage capacity of the paper feed cassette is equal to or more than a predetermined amount is determined (step S108). If the sheet storage capacity of the paper feed cassette is equal to or more than the predetermined amount, since it probably takes much time to supply sheets to the paper feed cassette, the image stabilization operation is executed utilizing the time during which the sheets are supplied (step S104). On the other hand, if the sheet storage capacity of the paper feed cassette is less than the predetermined amount (step S108), since it probably does not take much time to supply sheets to the paper feed cassette, the image stabilization operation is not executed.

Needless to say, even if the standard determination conditions are not satisfied, when the user or the maintenance operator needs the image stabilization operation, the image stabilization operation may be executed.

FIG. 3 shows a flowchart showing another example of the control of the image stabilization operation. The control described here is assumed on a plurality of paper feed cassettes, a plurality of sensors that detect whether or not sheets are present in the paper feed cassettes and a switching portion of switching the paper feed cassette that supplies sheets. Since the flowchart shown in FIG. 3 is the same as the flowchart shown in FIG. 2 in steps S101 to S107, the description thereof will not be repeated, and the control in step S109 and the subsequent steps will be described.

If in step S107, it is determined that there is no sheet in the paper feed cassette, whether or not the automatic switching of the paper feed cassette is set is then determined (step S109). If the automatic switching is set, the state of the paper feed cassette after being switched is received (step S110) whereas if there is no sheet in the paper feed cassette after being switched (step S111), the image stabilization operation is executed (step S104). On the other hand, if there is a sheet in the paper feed cassette after being switched (step S111), the process returns to step S101, if the automatic switching is not set (step S109), whether or not the sheet storage capacity of the paper feed cassette is equal to or more than the predetermined amount is determined (step S112). Then, if the sheet storage capacity is equal to or more than the predetermined amount, the image stabilization operation is executed (step S104) whereas if the sheet storage capacity is less than the predetermined amount, the process returns to step S101.

FIG. 4 shows a flowchart showing yet another example of the control of the image stabilization operation. The flowchart shown in FIG. 4 is the same as the flowchart shown in FIG. 3 in steps S101 to S112. The example of the control of the image stabilization operation in FIG. 4 differs from the example of the control of the image stabilization operation in FIG. 3 in that, even when a sheet is stored in the paper feed cassette after being switched (step S111), if the sheet stored in the paper feed cassette before being switched differs in the type from the sheet stored in the paper feed cassette after being switched (step S113), the image stabilization operation is executed (step S104). In this way, the degradation of image quality caused by the change of the type of sheet is reduced. The type of sheet stored in each paper feed cassette is previously input from an input portion such a touch panel, and is stored in a storage portion.

In another example of the control of the image stabilization operation, before sheets in the paper feed cassette run out, information that sheets runs out shortly may he displayed on a display panel (display portion), and whether or not the image stabilization operation is needed may be input from the input portion. FIG. 5 shows a partial flowchart showing this example of the control. The flowchart shown in FIG. 5 is a flowchart that is interposed between steps S106 and 5107 of the flowchart of the example of the control shown in FIGS. 2 to 4.

Specifically, if the state of the paper feed cassette is received (step S106), and the remaining number of sheets is equal to or less than a predetermined number of sheets (step S202), a display indicating that sheets in the paper feed cassette run out (step S203) and a display indicating that whether or not the image stabilization operation is needed is determined are produced (step S204). FIG. 6 shows an example of a display when a sheet switching portion is not present; FIG. 7 shows an example of a display when the sheet switching portion is present. As the portion for detecting the remaining number of sheets in the paper feed cassette, a conventionally known portion can be used; for example, the portion disclosed in JP-A-7-237759 can he used.

Then, the information on whether or not the image stabilization operation is needed that is input from the input portion is received (step S205), and, if the image stabilization operation is needed, in step S107, whether or not there is a sheet in the paper feed cassette is determined. On the other hand, if the image stabilization operation is not needed, the process returns to step S101 where the standard determination information is received.

Although the embodiment described above deals with the example where the image stabilization operation is executed when sheets are supplied to the paper feed cassette, the image stabilization operation may be executed when the constituent member of the apparatus such as an image production unit is replaced or a consumable item such as the toner is supplied. When it takes much time to perform the replacement or the supply described above, the image stabilization operation is executed utilizing the time during which the replacement or the supply is performed, and thus it is possible to execute the necessary image stabilization operation without the user feeling an increase in downtime.

In the image forming apparatus of the present invention, when the constituent member of the apparatus is replaced and/or the consumable item is supplied, whether or not the image stabilization operation can be executed is determined, and the image stabilization operation is executed only when it can be executed, with the result that it is possible to execute the image stabilization operation without an increase in downtime.

In the image forming apparatus of the present invention, since the image stabilization operation is executed utilizing the time during which sheets are supplied to the sheet storage portion having a large storage capacity where it takes much time to supply sheets, the downtime is prevented from being increased.

When in the apparatus, a plurality of sheet storage portions are provided, and the sheet storage portion that supplies sheets can he switched, since the image stabilization operation is executed when there is no sheet in the sheet storage portion before and after the switching or when the types of sheets stored in the sheet storage portions before and after the switching are different, the downtime is prevented from being increased and the image quality is prevented from being degraded.

Furthermore, when the display portion that notifies the necessity of the replacement of the constituent member of the apparatus and/or the supply of the consumable item and that previously produces a display for inquiring whether or not the execution of the image stabilization operation is needed and the input portion through which whether or not the execution of the image stabilization operation is needed is input are provided, it is possible to execute the image stabilization operation, with consideration given to the allowance of the user on downtime and the like, at a time suitable for the actual situation.

What is claimed is:

1. An image forming apparatus that can execute an image stabilization operation, the image forming apparatus comprising:
a determination portion that determines whether or not the image stabilization operation can be executed when a constituent member of the apparatus is replaced or when a consumable item is supplied; and
an image stabilization control portion that executes the image stabilization operation when the determination portion determines that the image stabilization operation can be executed.

2. The image forming apparatus of claim 1, further comprising:
a sheet storage portion that stores a sheet; and
a detection portion that detects whether or not the sheet is present in the sheet storage portion,
wherein, when the detection portion detects that no sheet is present in the sheet storage portion and that the sheet needs to be supplied, the determination portion determines that the image stabilization operation can he executed when a sheet storage capacity of the sheet storage portion is equal to or more than a predetermined amount, and the image stabilization control portion executes the image stabilization operation.

3. The image forming apparatus of claim 1, further comprising:
a plurality of sheet storage portions that store sheets;
a plurality of detection portions that detect whether or not the sheets are present in the sheet storage portions; and
a switching portion that switches the sheet storage portion which supplies the sheet,
wherein, when the detection portion detects that no sheet is present in the sheet storage portion which supplies the sheet and that the sheet needs to he supplied, the detection portion further detects whether or not the sheet is present in the sheet storage portion after being switched by the switching portion,
the determination portion determines that the image stabilization operation can be executed when no sheet is present in the sheet storage portion after being switched by the switching portion and
the image stabilization control portion executes the image stabilization operation.

4. The image forming apparatus of claim 1, further comprising:
a plurality of sheet storage portions that store sheets;
a plurality of detection portions that detect whether or not the sheets are present in the sheet storage portions;
a switching portion that switches the sheet storage portion which supplies the sheet;
a first input portion that inputs types of sheets stored in the sheet storage portions; and
a storage portion that stores the types of sheets input by the first input portion,
wherein, when the detection portion detects that no sheet is present in the sheet storage portion which supplies the sheet and that the sheet needs to be supplied, the detection portion further detects whether or not the sheet is present in the sheet storage portion after being switched by the switching portion,
the determination portion determines that the image stabilization operation can be executed when no sheet is present in the sheet storage portion after being switched by the switching portion, and when the sheet is present in the sheet storage portion after being switched and the type of the sheet stored in the sheet storage portion before being switched differs from the type of the sheet stored in the sheet storage portion after being switched and
the image stabilization control portion executes the image stabilization operation.

5. The image forming apparatus of claim 1, further comprising:
a display portion that previously notifies necessity of the replacement of the constituent member of the apparatus and/or of the supply of the consumable item and that previously produces a display for inquiring whether or not the execution of the image stabilization operation is needed; and
a second input portion that inputs whether or not the execution of the image stabilization operation is needed,
wherein, when information that the execution of the image stabilization operation is not needed is input from the second input, portion, even if the determination portion determines that the image stabilization operation can be executed, the image stabilization control portion does not execute the image stabilization operation.
